(19) United States
(12) Patent Application Publication
(10) Pub. No.: US 2020/0324693 A1
(43) Pub. Date: Oct. 15, 2020

(54) ILLUMINATION FOR VEHICLE INTERIOR

(71) Applicant: KARMA AUTOMOTIVE LLC, Irvine, CA (US)

(72) Inventors: Adelaide Begalli, San Mateo, CA (US); Andre Franco Luis, Orange, CA (US); Steve Ingram, Lake Forest, CA (US)

(73) Assignee: KARMA AUTOMOTIVE LLC, Irvine, CA (US)

(21) Appl. No.: 16/379,633

(22) Filed: Apr. 9, 2019

(51) Int. Cl. B60Q 3/54; B62D 65/14; B60Q 3/62

(52) U.S. Cl. CPC B60Q 3/54; B60R 13/02; B60Q 3/62; B62D 65/14

(57) ABSTRACT

A vehicle including illuminated stitching as a trim on a vehicle interior surface. The method for installing the illuminated stitching includes cutting a continuous channel into the vehicle interior surface. The method also includes installing an illuminated fiber into the channel. The illuminated fiber is at least partially exposed and emits light. The illuminated fiber is secured in the channel to ensure the fiber stays in the channel.

### BACKGROUND

The present disclosure relates to a method for installing an illuminated fiber as a trim for a vehicle interior surface, and particularly where installing includes using a laser etcher to cut, etch, score or gouge a channel in which to seat the illuminated fiber.

Specialized lighting elements are frequently installed in vehicle interiors to add to a sense of luxury and value. Such specialization may include installing LED fiber optics or other illuminated fibers as trimming for a section of a surface, such as the LED fiber optic seat cover disclosed in U.S. Pat. No. 6,854,869 (incorporated by reference herein). It is possible to go beyond the simple addition of an illuminated fiber optic, however, and additional embellishments may be added through embedding the illuminated fiber in the vehicle interior surface and securing the illuminated fiber into place with a variety of decorative methods.

It is desirable to develop a method for quickly creating a channel, especially a channel created in a desired location, to guide the installation of an embedded and secured illuminated fiber in vehicle interior surfaces.

### SUMMARY

Disclosed herein is a method for installing an illuminated fiber as a trim element in a vehicle interior surface, and particularly where installing includes using a laser to create a channel in which to seat the illuminated fiber. In one embodiment, the method comprises creating a channel in the interior surface, installing an illuminated fiber into the channel, and securing the illuminated fiber in the channel. In one embodiment, the channel is a continuous line. In one embodiment, the illuminated fiber is at least partially exposed and emits light.

In another disclosed embodiment, the channel may be created by means of scoring, etching, cutting, or gouging. In another disclosed embodiment, the scoring, etching, cutting, or gouging is performed by a laser. In another disclosed embodiment, the channel is created at a depth that allows the exposed portions of the illuminated fiber to sit flush with the surface. In another disclosed embodiment, the channel has at least one curve. In another disclosed embodiment, the channel is created in the surface in a manner that presents a design pattern.

In another disclosed embodiment, installing includes applying adhesive to the channel before installing the illuminated fiber.

In another disclosed embodiment, securing includes stitching a thread over at least a portion of the illuminated fiber. In another disclosed embodiment, securing includes heat sealing at least a portion of the illuminated fiber.

In another disclosed embodiment, the illuminated fiber is connected to a lighting control device, wherein the lighting control device determines the color and intensity of the light to be emitted by the illuminated fiber.

In another disclosed embodiment, the vehicle interior surface is comprised of a material that allows for sharp embossment to lodge the illuminated fiber within. In another disclosed embodiment, the vehicle interior surface may include at least one material from the set of leather, wood, metal, and plastic.

Other aspects, features, and techniques will be apparent to one skilled in the relevant art in view of the following detailed description of the embodiments.

### BRIEF DESCRIPTION OF THE DRAWINGS

The features, objects, and advantages of the disclosed embodiments will become more apparent from the detailed description set forth below when taken in conjunction with the drawings in which like reference characters identify correspondingly throughout and wherein:

FIG. 1 is a perspective view of an exemplary embodiment of a vehicle in which an illuminated fiber may be installed.

FIG. 2 is a perspective view of an exemplary embodiment of a vehicle interior surface with an illuminated fiber installed in a channel.

FIG. 3 is a top view of an exemplary embodiment of a vehicle interior surface with an illuminated fiber installed in a channel.

FIG. 4 is a sectioned side view of the vehicle interior surface with an illuminated fiber installed in a channel depicted in FIG. 3, taken along the line 4-4.

FIGS. 5A and 5B are top views of an exemplary embodiment of a portion of a vehicle interior surface with an illuminated fiber installed and fixed into place with stitching. FIG. 5C is a top view of an exemplary embodiment of a portion of a vehicle interior surface with an illuminated fiber installed and fixed into place with stitching, wherein an additional surface layer with perforations is included above the illuminated fiber.

FIG. 6 is a perspective view of an exemplary embodiment of a process for creating a channel in a vehicle interior surface using a laser.

FIG. 7 is a graphic depiction of an exemplary embodiment of an illuminated fiber control system.

### DETAILED DESCRIPTION

One aspect of the disclosure is directed to a method for installing an illuminated fiber as a trim for a vehicle interior surface.

References throughout this document to “one embodiment,” “certain embodiments,” “an embodiment,” or similar term mean that a particular feature, structure, or characteristic described in connection with the embodiment is included in at least one embodiment. Thus, the appearances of such phrases in various places throughout this specification are not necessarily all referring to the same embodiment. Furthermore, the particular features, structures, or characteristics may be combined in any suitable manner on one or more embodiments without limitation. For example, two or more of the illuminated fiber embodiments described herein may be combined in a single device, but the application is not limited to the specific exemplary combinations of an illuminated fiber or of methods for installing an illuminated fiber that are described herein.

As used herein, the terms “a” or “an” shall mean one or more than one. The term “plurality” shall mean two or more than two. The term “another” is defined as a second or more. The terms “including” and/or “having” are open ended (e.g., comprising). The term “or” as used herein is to be interpreted as inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

A detailed description of various embodiments is provided; however, it is to be understood that the disclosed embodiments are merely exemplary and may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the disclosed embodiments.

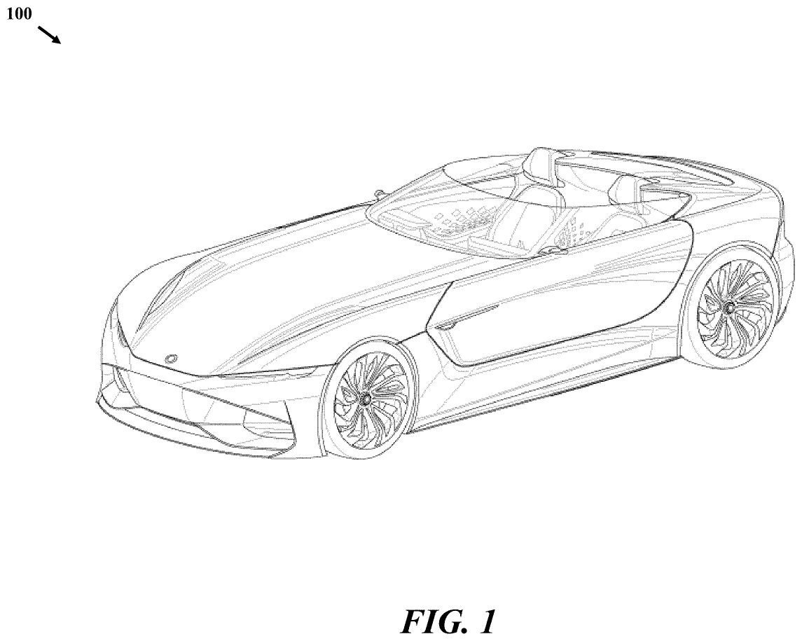

FIG. 1 is a perspective view of an exemplary embodiment of a vehicle 100 in which an illuminated fiber 220 may be installed. The vehicle 100 is depicted as a sports vehicle, but the method of installing an illuminated fiber 220 described may be used with any passenger vehicle or other vehicle with interior surfaces to be decorated.

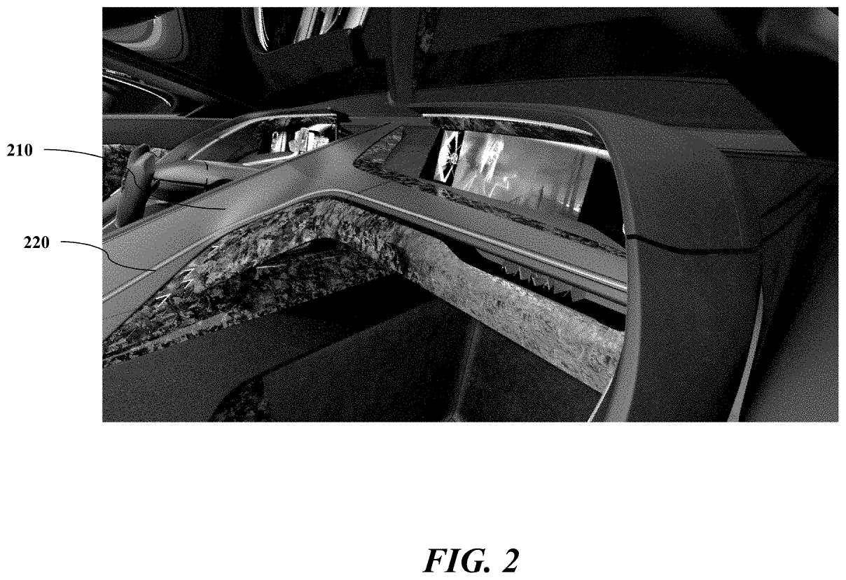

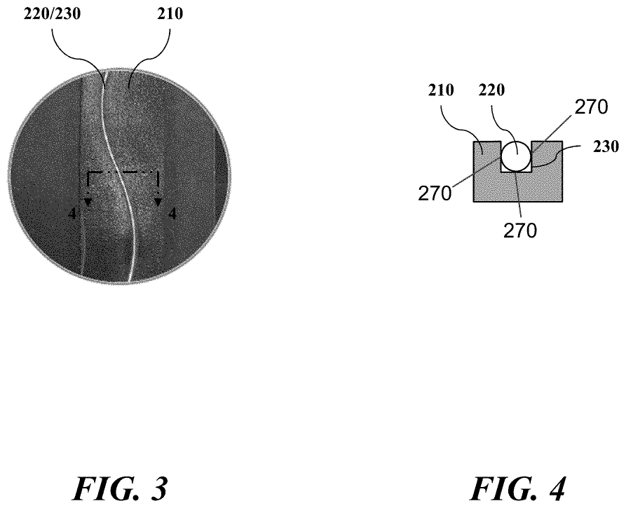

FIG. 2 is a perspective view of an exemplary embodiment of a vehicle interior surface 210 with an illuminated fiber 220 installed in a channel 230. FIG. 3 is a top view of an exemplary embodiment of a vehicle interior surface 210 with an illuminated fiber 220 installed in a channel 230. According to one embodiment, the channel 230 may have at least one curve in its path, allowing for more creative arrangement of the illuminated fiber 220 than a straight gouged channel 230 would allow. The channel 230 may be arranged in a manner that presents a design pattern. According to one embodiment, at least a portion of the illuminated fiber 220 may be secured in place by heat sealing.

FIG. 4 is a sectioned side view of the vehicle interior surface 210 with an illuminated fiber 220 installed in a channel 230 depicted in FIG. 3, taken along the line 4-4. In one embodiment, the channel 230 is deep and wide enough to accommodate the diameter of the illuminated fiber 220, such that when the illuminated fiber 220 is installed into the channel 230, it sits flush with the rest of the vehicle interior surface 210.

According to one embodiment, the illuminated fiber 220 may be secured to the channel 230 by an adhesive. The dimensions of the channel 230 may be adjusted accordingly such that the illuminated fiber 220 still sits flush with the vehicle interior surface 230 even with the additional thickness of the adhesive.

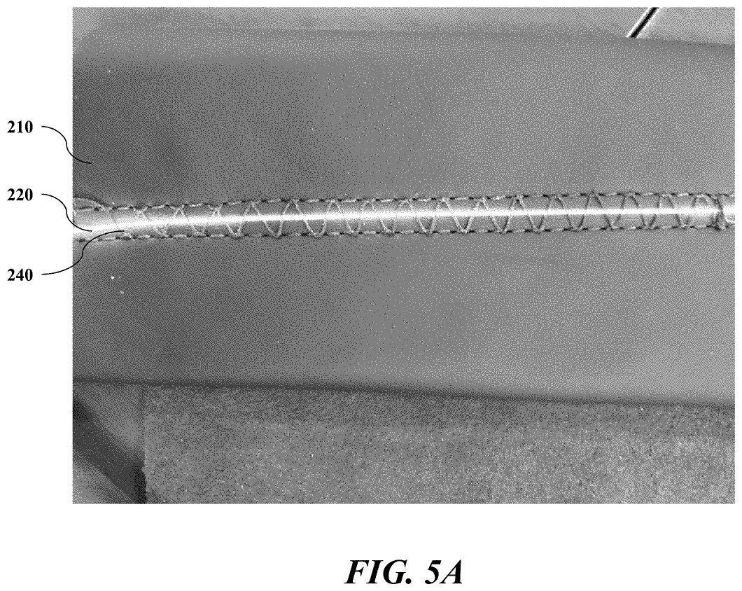

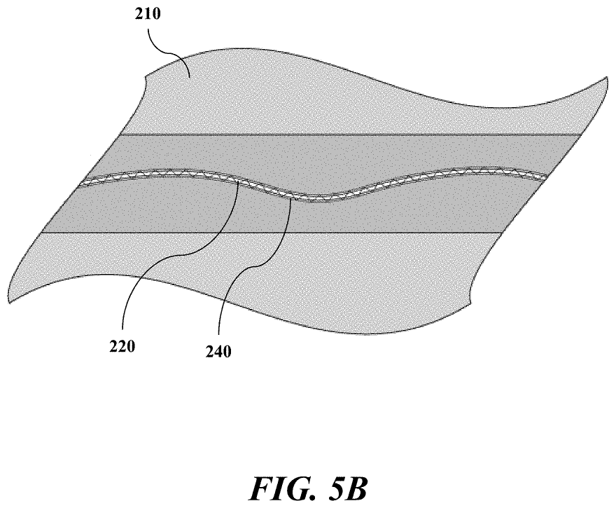

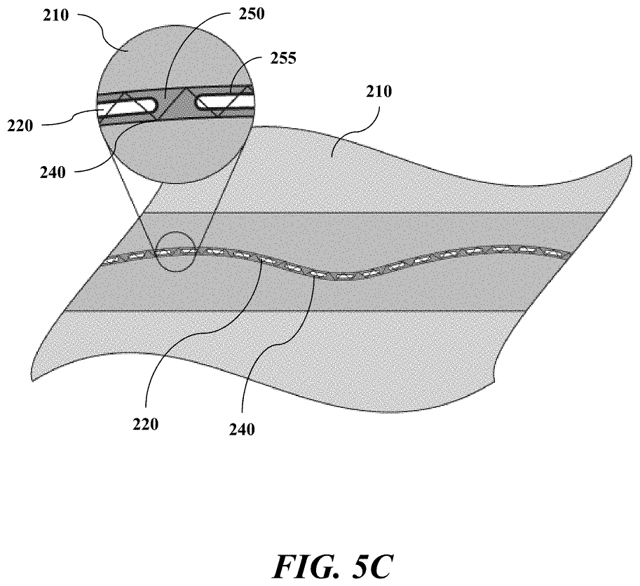

FIGS. 5A and 5B are top views of an exemplary embodiment of a portion of a vehicle interior surface 210 with an illuminated fiber 220 installed and fixed into place with stitching 240. The stitching 240 may be colored to match or complement the vehicle interior surface 210, or the stitching 240 may be translucent to allow the illuminated fiber 220 to emit light through it. The stitching 240 may be a French Seam.

FIG. 5C is a top view of an exemplary embodiment of a portion of a vehicle interior surface 210 with an illuminated fiber 220 installed and fixed into place with stitching 240, wherein an additional surface layer 250 with perforations 255 is included above the illuminated fiber 220. The illuminated fiber 220 may be used in combination with different perforation points instead of decorating the vehicle interior surface 210 as a continuous line, allowing for a wide variety of stitching or embroidery effects with the illuminated fiber 220. In one embodiment, the illuminated fiber 220 is visible through the perforations 255 and concealed by all other portions of the additional surface layer 250. In another embodiment, the illuminated fiber 220 is woven through the perforations 255. In another embodiment, the additional surface layer 250 includes additional perforations for decorative threads such as, for example, the stitching 240. The additional surface layer 250 may be a decorative material such as, for example, leather.

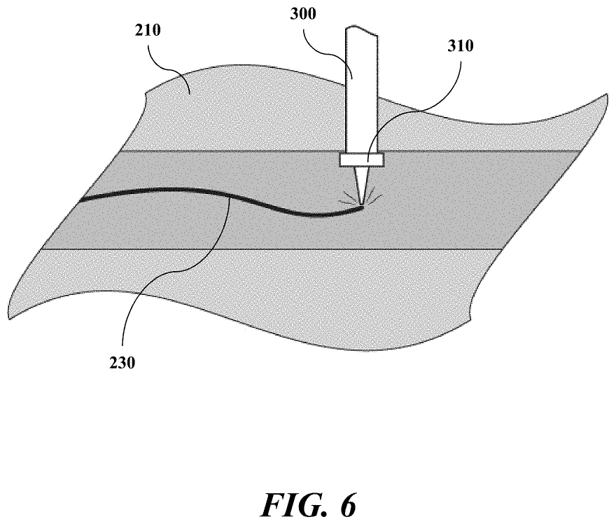

FIG. 6 is a perspective view of an exemplary embodiment of a process for creating a vehicle interior surface 210 using a laser 300. The laser 300 may employ a cutting, scoring, etching or gouging process to create a channel 230. A laser 300 may use a laser head 310 to trace the path of the channel 230. The use of a laser 300 may allow for more refined control of the path of the channel 230, providing the ability to create more intricate channel designs with a greater speed than would be possible with more traditional methods. According to one embodiment, the laser 300 may create the channel 230 before the vehicle interior surface 210 is installed in the vehicle 100.

One of the advantages of using a laser 300 to create the channel 230 is that the process may allow for the ablation of multiple types of materials that may be used for the vehicle interior surface 210, including but not limited to leather, wood, metal, and plastic. In one embodiment, a single laser 300 may accomplish the task of creating the channel 230 in a variety of surfaces with a simple adjustment of settings, as opposed to the creation of an entirely different tool.

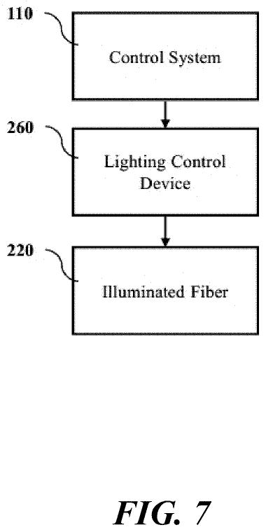

FIG. 7 is a graphic depiction of an exemplary embodiment of an illuminated fiber 220 control system. According to one embodiment, a control system 110 of the vehicle 100 may convey instructions to a lighting control device 260. The lighting control device 260 may, in turn, determine the color and intensity of the light to be emitted by the illuminated fiber 220. The lighting control device 260 may further alter the color and intensity of the light to be emitted by the illuminated fiber 220 during operation of the vehicle 100.

While this disclosure makes reference to exemplary embodiments, it will be understood by those skilled in the art that various changes in form and details may be made therein without departing from the scope of the claimed embodiments.

1. A method for installing an illuminated fiber as a trim for a vehicle interior surface, the method comprising:
creating a continuous channel in a layer of material located on the vehicle interior surface with a laser, wherein said channel created by the laser has a depth that is less than the thickness of the layer of material so that the walls of the channel facing the illuminated fiber are continuous;
installing the illuminated fiber in the channel, wherein the illuminated fiber is at least partially exposed to the interior of the vehicle and emits light; and
securing the illuminated fiber in the channel.

2. (canceled)

3. The method of claim 1, wherein the depth allows the exposed portions of the illuminated fiber to sit flush with the rest of the vehicle interior surface.

4. The method of claim 1, wherein the channel has at least one curve.

5. The method of claim 1, wherein the channel is created in a manner so that the illuminated fiber gives off a pattern of light.

6. The method of claim 1, wherein the step of installing includes applying adhesive to the channel before installing the illuminated fiber.

7. The method of claim 1, wherein the step of securing includes stitching a thread over at least a portion of the illuminated fiber.

8. The method of claim 1, wherein step of securing includes heat sealing at least a portion of the illuminated fiber.

9. The method of claim 1, wherein the illuminated fiber is connected to a lighting control device, wherein the lighting control device determines the color and intensity of the light to be emitted by the illuminated fiber.

10. The method of claim 1, wherein the vehicle interior surface is comprised of a material that allows for embossment to lodge the illuminated fiber within.

11. A vehicle including an illuminated fiber positioned along an interior surface, comprising:
a continuous channel formed in a layer of material located on the vehicle interior surface via a laser, wherein said channel created by the laser has a depth that is less than the thickness of the layer of material so that the walls of the channel facing the illuminated fiber are continuous;
the illuminated fiber located in the channel, wherein the illuminated fiber is at least partially exposed to the interior of the vehicle and emits light; and
the illuminated fiber being secured in the channel.

12. (canceled)

13. The vehicle of claim 11, wherein the depth allows the exposed portions of the illuminated fiber to sit flush with the rest of the vehicle interior surface.

14. The vehicle of claim 11, wherein the channel has at least one curve.

15. The vehicle of claim 11, wherein the channel is formed so that the illuminated fiber displays a pattern of light.

16. The vehicle of claim 11, further comprising adhesive located in the channel for retaining the illuminated fiber.

17. The vehicle of claim 11, further comprising a thread stitched over at least a portion of the illuminated fiber to thereby retain the fiber in position.

18. The vehicle of claim 11, wherein at least a portion of the illuminated fiber is retained in position in the channel via a heat sealing process.

19. The vehicle of claim 11, wherein the illuminated fiber is connected to a lighting control device, wherein the lighting control device determines the color and intensity of the light to be emitted by the illuminated fiber.

20. The vehicle of claim 11, wherein the vehicle interior surface is comprised of a material that allows for embossment to lodge the illuminated fiber within.
